(19) United States
(12) Patent Application Publication
(10) Pub. No.: US 2010/0144306 A1
(43) Pub. Date: Jun. 10, 2010

(54) CELL PHONE FM RECEIVER EMERGENCY ALERT METHOD AND APPARATUS

(76) Inventor: Lawrence J. Karr, Santa Monica, CA (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/632,271

(22) Filed: Dec. 7, 2009

Related U.S. Application Data
(60) Provisional application No. 61/120,157, filed on Dec. 5, 2008.

(51) Int. Cl. H04M 11/04

(52) U.S. Cl. 455/404.1

(57) ABSTRACT

FM-based emergency alert systems and methods are very reliable, intrude only minimally on program material, leave battery life unchanged, and do not add to the cost of embedding FM reception in portable electronic devices such as cellular handsets. For compatibility with intermittently operating, low-energy-consumption FM receivers in cell phones, an alerting signal spanning at least the wake-up period of the FM receiver is transmitted prior to data transmission. The receiver may wake up at a rate of a few tenths of a hertz to a few hertz. Various modulation schemes may be used for the transmitted signal. After a sufficient amount of incoming signal is detected, an alarm or data relating to an emergency situation may be received. A plurality of transmitters may be used to transmit the signal redundantly.

### REFERENCE TO RELATED APPLICATION

This application claims priority from U.S. Provisional Patent Application Ser. No. 61/120,157, filed Dec. 5, 2008, the entire content of which is incorporated herein by reference.

### FIELD OF THE INVENTION

This invention relates generally to RF alert systems and, in particular, to an FM receiver integrated into a cell phone handset enabling emergency alert system (EAS) messages to be received reliably when the cell phone handset is on standby or active.

### BACKGROUND OF THE INVENTION

### FM Receivers and Small Antennas

A modern FM receiver chip is a very small piece of silicon. A chip area of 7 square millimeters is probably the upper limit for an FM receiver implemented in modern bulk CMOS (geometry of 130 nm of less).

The Microsoft MSN Direct receivers, built in large geometry CMOS (180 nm feature size) measure 2.7 by 2.7 millimeters. A contemporary design would use less area, probably 4 square millimeters. The Microsoft receivers used a standard 10.7 MHZ IF and external ceramic filters. The use of ceramic filters improves selectivity and dynamic range, but adds 30 or 40 cents to the bill of materials, and about 20 square millimeters to the PCB area. This would not likely be the method of choice today. Despite this, the MSN receivers were integrated onto wristwatch circuit cards.

Generally, an FM receiver function needs, in addition to the receiver silicon, an antenna of some sort, some capacitors (mostly for bypass purposes), and an appropriate stable clock. The clock may be provided from an already existing clock in the cell handset, or a dedicated crystal. The PCB area devoted to FM reception (excluding any antenna integrated onto the PCB) is probably between 40 and 100 square millimeters, without using any shared resources of the handset. The cost of this much silicon is about a dollar, and assembly plus other parts might increase this by one dollar in large quantities (millions). Thus, the all-up cost will be less than 2 dollars inclusive. The NXP (formerly Philips) TEA5990 is rumored to cost about 70 cents in quantities of a few hundred thousand.

An FM receiver in a cell phone environment may well share memory, in which case the memory used is inconsequential compared to the cell phone memory footprint. If the function is segregated, then the firmware might occupy a few tens of kilobytes of flash memory and the device might use a few thousand bytes of RAM. The chip area for this memory should total less than one square millimeter.

An analysis of FM receivers and antennas cannot be done without an understanding of the noise environment in the FM band. Typical noise levels in suburban areas are 25 db above thermal noise with an isotropic antenna, and in urban areas, this increases to about +40 db. Even in very remote essentially unpopulated areas, galactic and solar noise will be 5 decibels above KTB (thermal noise). Thus, in populated areas, one expects noise to be at least 25 db above thermal. This is both good and bad. If, in a populated area, we had a very low noise receiver and used an antenna with 0 db gain with respect to isotropic, we could attenuate the signal from that antenna by about 25 db before we experienced a significant reduction in effective FM sensitivity. Alternatively, we could use an antenna which was −25 db with respect to isotropic or −28 db with respect to a dipole, without significant loss of effective sensitivity. This seems unrealistic at first blush, but some numeric examples should help.

The “urban contour” of an FM broadcast station is customarily defined as the region where the outdoor field strength is equal to or greater than 60 db μV per meter, or 1 mV per meter. With this field strength, a dipole antenna will collect a −53 dbm signal. The suburban noise collected will be about −95 dbm, which would ideally yield an FM signal to noise ratio of the order of 60 db, considering capture and pre-emphasis effects. A “terrible” antenna with a sensitivity of −20 db with respect to a dipole will give essentially the same S/N performance, since the signal and the excess noise would both be reduced by 20 db.

Note that many FM receivers are made with a noise figure of only a few db, but this is, with normal antennas, an exercise in overkill. With very small inefficient antennas, a low noise front end actually matters. Thus, cell phone FM receivers need low noise figures.

The theory of electrically small antennas was begun by Wheeler in about 1947, significantly advanced by Chu in 1948 and extended in 1960 by Harrington. SCA Data Systems explored the theoretical and practical limits of electrically small tuned antennas while developing wristwatch radios for Microsoft. Several companies manufactured wrist receivers for this system, including Fossil, Swatch and Suunto. Fossil used a wrist loop antenna. Swatch used a smaller variant wrist antenna. Suunto built their (very small) loop antenna into a bezel around the watch dial. All of these wrist receivers worked quite well. Since the subcarrier signal was −26 db with respect to the main carrier power, the main audio would always be adequately received if the high speed data subcarrier was decodable. This is a good indication that RDS signals would be received under the same circumstances, since the data throughput of MSN direct is about 20 times that of RDS. MSN Direct is vastly more efficient than RDS, but the 20× speed makes the comparison compelling, as MSN Direct is only about 10 times better in Eb/No. The SCA developed chips used automatic loop tuning, using a scheme patented by the present Applicant.

Silicon Labs have recently introduced FM receiver chips which have the advertised feature that they do not require an earphone cord for reception, and have provision for automatically tuning resonant loops. The older Si4702/4703 use headphone cords. The Si4704/4705 support “embedded antennas,” which practically means tuned loops. Some additional information can be found in Silicon Labs application note AN383, which indicates which of their devices can operate with embedded antennas. Note that the stated advantage of the loop form is higher efficiency. Their chips include antenna tuning provisions. Some of the other merchant manufacturers may also include on-chip tuning capacitors.

FIG. 1 shows the limits of small antennas in terms of their size, bandwidth and efficiency. The size here is the greatest dimension of the antenna, since the relationship happens to be in terms of the size of a sphere entirely enclosing the antenna. Antennas approaching performance limits in terms of size and efficiency must necessarily be relatively narrow band in order to stay tuned.

In some cases, an antenna can be tuned to receive the entire FM band, but it is likely that antennas for this application would need automatic tuning to particular frequencies. The plot of FIG. 1 shows that for a Q of 10 (about right for the FM band without variable tuning), an optimal antenna would have a 4.5 cm size for −30 db performance. The loop referred to in the plot is one with a 20 cm circumference and a high Q. Antenna tuning is not difficult, and is normally done with digitally controlled on-chip capacitors, which are often metal insulator metal (MIM) capacitors and have a very high Q. These are switched with on-chip analog switches, thus realizing fully integrated digitally controlled tuning capacitor arrays. Note that a Q of about 300 would be the maximum for broadcast FM reception, since Q value exceeding that figure would start to interfere with the station's modulation. In practice, unloaded Q values will not much exceed about 100. The author has two issued patents covering antenna tuning means, and these have useful references in the form of cited prior art. There are many ways to tune resonant antennas.

Tuned loops or slots offer respectable performance where antennas must be small. The absolute requirement is that the internal antenna be adequate for reliable reception of emergency alerts. Small tuned antennas typically present very high impedances to connecting circuitry, since they take the form of a parallel tuned resonant circuit. In addition, these antennas are often balanced. CMOS chip designs can advantageously use these properties, since the noise figure of CMOS is very good for impedances of thousand of ohms. Further, balanced or differential antenna inputs tend to minimize the effect of internal digital noise and the like.

The placement of the internal FM antenna is important in three ways. The antenna performance will vary according to the proximity of the user's body. The tuning of the antenna will vary as well, and must be adjusted for such. Finally, the antenna needs to be placed so that it is not terribly impaired by conductive and/or lossy materials in the cellular handset. This placement must be determined on a case by case basis. The antenna in the commercially available Suunto n3 “Smart Watch,” for example, utilizes a copper ring around the dial. Connections to the tuning capacitors and the differential RF LNA are made to a split in the ring.

In summary, a properly designed embedded antenna should perform as well as a headphone cord antenna in most circumstances. In some cases, the radio receiver will perform better due to the band-pass tuning of the embedded antenna, which will improve overload performance. This is important because an emergency alerting function must not rely on the presence of the headphone cord antenna. The embedded antenna may take the form of a loop, slot or a stub. Embedded antennas without a tuning mechanism, however, are unlikely to be satisfactory.

### Emergency Alerting Function

There is great interest in an FM radio based emergency alerting function for cell-phones. This is particularly important for CDMA phones, which are dominant in the US market, since the CDMA protocol is less well adapted to broad emergency alerts. Curiously, most FM radios installed in cell phones are in GSM phones. An emergency alerting function needs to be dependable above all else, and must be universally implemented. A few points are evident:

1. The emergency alerting function must not impair basic cell-phones performance. This means non-interference with the cellular receiver, and not meaningfully reducing the standby time of the cell-phone. Compact cell-phones may have a standby time of 200 hours, and use a lithium-ion battery with a 2 watt-hour capacity. If we expect no more than a 10 percent reduction in standby time as a result of the emergency alerting function, then that alerting system needs to operate on an average power of 1 milliwatt (i.e. average standby power is roughly 2 W-hr/200 hrs, or 10 mW, and ten percent of that is 1 mW).

2. There are no adequate FM radios which will operate on 1 mW, our emergency alerting reception will use an intermittently operating receiver. If we choose 2 seconds as an allowable alert time delay, then the device must awaken at least once in a 2 second time period. Since this wake-up function will not in general be synchronous with the timing of possible alerts, the alerting signal needs to be of a nature so that it can be acquired asynchronously. For the moment, assume a 40 millisecond “on” time for the FM receiver and alerting hardware. This is a 2 percent duty cycle, allowing the alerting receiver to consume 50 mW or so while active. This power consumption is a reasonable goal for a carefully designed single chip FM receiver.

3. If the FM receiver is not operating while the cell-phone is in talk mode, then it probably will not impact the cell phone's communication performance. While it is possible that some FM antenna structure might compromise cellular communication, such designs may be avoided. FM reception may be adversely affected by the cell-phone transmitter while it is active. As such, we might want to operate the FM receiver during transmitter idle periods, using a high-level control. Experiment shows that a CDMA cell phone can be operated very near an FM radio without obvious impairment of FM reception.

4. The dependability of the alerting function relies on the universality of the system, and on its technical robustness. It is extraordinarily unlikely that all the FM stations in a metropolitan area would cease operating, barring a truly remarkable catastrophe, since stations tend to have back-up redundant power sources, transmitters, antennas, and so forth. When evaluated from an overall system point of view, if all FM stations had the emergency alerting function in operation, then there is no reasonable way that, in a city, the signal would fail to be sent.

5. To avoid single station failure problems, the emergency alerting receivers according to the invention will scan the FM band periodically to determine which frequencies are active. This requires only the use of a frequency agile receiver, and a simple RSSI detector, which can be supplemented with stereo pilot detection and quality estimation. This cataloging can be done invisibly to the emergency monitoring function, since almost all of the time the FM radio is inactive. Presumably when the FM radio is in use, it will be tuned to a station where the alert signal can be received.

### Emergency Alerting Signals

Old EBS—The old Emergency Broadcast System (EBS) two tone audio alert signal (853 hz+960 hz) could easily be detected by an intermittently operating receiver, since that signal spanned quite a few seconds. In addition, we consider that signal to have been very robust, since it could have been detected under very poor reception conditions and with a weak signal and/or a poor antenna. However, this system is now obsolete, and was never designed to carry additional information.

Current EAS—The currently-used emergency alert system (EAS) signals with coded preamble and encoded digital message cannot be readily retrieved by an intermittently operating receiver since the 16-byte preamble is sent for a short period of about 250 milliseconds. The EAS preamble and data signals themselves are robust. If the EAS two-tone signal were universally transmitted, it would serve as an automatically detectable alert. This is limited in its usefulness, since the data is transmitted first. We note that, by law, the EAS system signals may not be altered, likely removing this system from consideration.

A version of this signaling scheme (for intermittent receivers) according to this invention would place the two-tone alerting signal in front of the coded preamble and digital message, with a tone period exceeding 2 seconds. This would require that stations transmit an abbreviated version of the two-tone alert, interrupting normal programming, and then transmit the coded signals. If this were acceptable to the FCC and to the broadcasters, it would be effective.

RDS/RBDS Subcarriers—The REDS or RDS (Radio Broadcast Data System or Radio Data System) standards define emergency alerting protocols. However, RDS/RBDS are not designed for use by intermittently operating receivers, they lack an agreed upon standard group sequence, and they may be transmitted at rather low deviation. An emergency alerting flag is carried in 1A groups as defined in the US RBDS standard. An additional emergency alerting function is defined by setting the WA bit in group 3A, which must be sent at least once per second. 1A groups are not in general transmitted in a fixed cadence, unless the particular RBDS system is configured for radio paging, per the old CUE paging system, which was really a version of the predecessor MBS system.

If the system is configured for radio paging, then 1A groups are transmitted once per second. This would allow an intermittent receiver to be used, especially if only part of the 1A group needed to be decoded. An RBDS group comprises 104 symbols, at an 1187.5 baud rate. This is a span of 87.5 milliseconds. To achieve a satisfactory duty cycle from an energy conservation point of view, the reception would need to be limited to once every 4 seconds, to achieve a 2 percent duty cycle.

The 3A group function is set up so that one needs to read the RBDS signal for typically one second in nine to find the 3A warning flag. This means a duty cycle of circa ten percent, which is too high for satisfactory battery life.

There are two basic problems with RBDS emergency alerting, one of which is unique to cell phone receivers. The cell phone embedded receiver problem is that the FM receiver is active too much of the time which will drain the battery. The other, more general problem is that RBDS reception is far less robust than mono audio, and may intermittently fail even with automotive antennas.

RDS alerting is not particularly robust in terms of noise and multipath. As such, many persons may not receive the alert. The RDS signals are reliable only when a receiver's mono audio S/N is about 40 db or greater, which does not lead to a robust and reliable alert A truly reliable emergency alerting system should operate well beyond the urban coverage of an FM station, and should work inside buildings with tinted windows, and in other marginal reception conditions.

### SUMMARY OF THE INVENTION

This invention resides in FM-based emergency alert systems and methods which are very reliable, intrude only minimally on program material, leave battery life unchanged, and do not add to the cost of embedding FM reception in portable electronic devices such as cellular handsets. In the preferred embodiments, an alerting signal spanning at least the wake-up period of the FM receiver is transmitted prior to data transmission to work with intermittently operating low energy consumption FM receivers in cell phones.

An FM alert system according to the invention includes a transmitter that transmits a signal on a normally inactive mono(L+R) in-band FM subcarrier, and a receiver that wakes up on a periodic basis to determine if the signal is present. According to preferred embodiments, the receiver wakes up at a rate of a few tenths of a hertz to a few hertz.

Various modulation schemes may be used for the transmitted signal, including binary phase-shift key (BPSK) modulation, frequency-shift key (FSK) modulation, minimum frequency-shift key or minimum-shift key (MSK) modulation, or continuous-phase modulation (CPM). The modulation may occur at 1000 baud, for example, using a pseudo-noise (PN) sequence. According to one specific embodiment, a pseudo-noise (PN) sequence of length 2̂5−1=31 lasting 2.108 seconds may be used.

The transmitted signal may be above 13 KHz. For example, the signal may be transmitted at 14 KHz using two tones about half a semitone apart resulting in 14.5 KHz and 14.925 KHz, in which case the receiver heterodynes the signal with 15 KHz and low pass filters at 1 KHz, yielding 500 Hz and 75 Hz signals as outputs when the alert is present.

After a sufficient amount of incoming signal is detected, an alarm or data relating to an emergency situation may be received. For example, the transmitted signal may followed by a data sequence comprising 16 rotated PN sequences (64 bits) for 0.496 seconds. A plurality of transmitters may be used to transmit the signal redundantly.

### BRIEF DESCRIPTION OF THE DRAWINGS

FIG. 1 is a graph showing the limits of small antennas in terms of size, bandwidth and efficiency; and

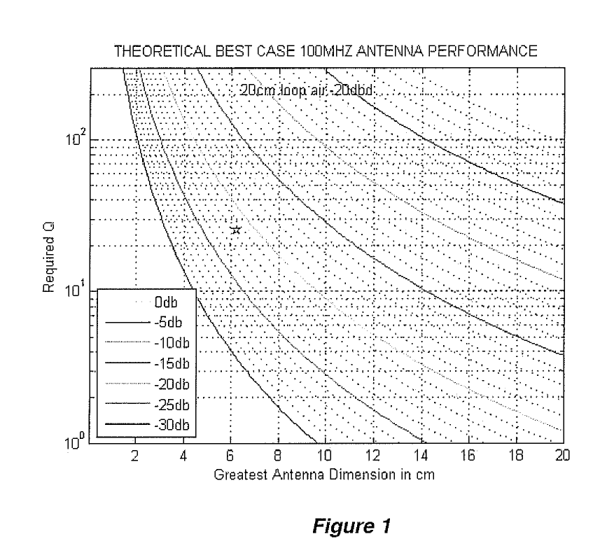

FIG. 2 depicts a signal encoding scheme according to the invention.

### DETAILED DESCRIPTION OF THE INVENTION

In accordance with this invention, an alerting signal spanning at least the wake-up period of the FM receiver is transmitted prior to data transmission to work with intermittently operating, low-energy-consumption FM receivers in cell phones or other hand-held devices. Assuming an acceptable span for an emergency alert is between one and ten seconds, a conforming receiver must wake up at a rate of a few tenths of a hertz to a few hertz. Assuming an FM receiver uses about 50 mW, then a cell phone battery which has a capacity of about 2 watt hours would run the FM radio continuously for 40 hours, which would be unacceptable. Assuming, then, a wake-up period of 2 seconds, and an average power consumption of 1 mW, we get a typical “on” period of 40 milliseconds for the receiver to detect an alert condition.

A large set of signals can be used for our alerting purpose, ranging from single sine waves to multi-frequency alerts or time-structured codes. To distinguish audio tones or other signals, the signals should not resemble normal program material. We found that lengthy 853 Hz+960 Hz tones at high levels are not plausible as music or speech, but are quite audible and annoying.

If tones are used, it probably suffices to use a few precisely known high frequencies, above about 13 KHz. For example, one could use a closely spaced tone pair at high frequency, which is something unlikely to occur in program material, especially if the frequency ratio is appreciably less than a semitone. At 14 KHz, one semitone up is 14.8325 KHz. If we were to use two tones about half a semitone apart, this could be done as 14.5 KHz and 14.925 KHz. In many instances, listeners wouldn't hear these frequencies, due to auditory or apparatus deficiencies.

Heterodyning the radio's mono audio with 15 KHz, and low pass filtering at 1 KHz gives 500 Hz and 75 Hz signals as outputs when the alert is present. These could be detected by various simple means. The peak amplitude of this signal would be 6 db above the individual tones, and the average power would be 3 db greater, resulting in a reasonable 3 db crest factor. If the intermittent receiver wakes up and detects this kind of pattern, it will continue in a powered up state for a while to confirm the presence of the signal. This method allows the elimination of false alarms. After a sufficient amount of this signal is detected, an alarm could be generated, or data could be received indicating to the cell phone user the nature of the emergency. This general technique requires some simple (probably DSP based) audio filters, and basic synchronizing and decoding circuitry. Typical DSP burden would be about ten arithmetic operations per sample at a sample rate of about 48000, which is quite modest.

The transmission of qualifying data should be as reliable as the alerting tone, or the altering system is seriously degraded. The most powerful means of sending a particular message is to use correlation techniques to find the message. The problem with this in general is that even with fast transform techniques, the computation is considerable, at least at first blush.

Using normal DSP methods, if a received sequence were 32 elements long and complex (real and imaginary terms), then a raw correlation would use 32*32*4=4096 multiplications and some additions. A fast transform method would reduce this somewhat, perhaps by a factor of 6 or 7.

If, however, one has a well-chosen pseudo-noise (PN) code, it is possible to use special correlation techniques, such as fast Walsh-Hadamard transforms, to detect the message with minimal processing. For a message sequence of length 31 this can be done with a total of 640 additions and no multiplications. Further, such correlation methods have large coding gains, allowing message information to be recovered correctly at very low S/N.

If we use such a PN code as both the alerting “tone” and data symbol, we easily accomplish the desired reliability equivalence, and the alerting tone also then serves as data synchronization. One could then pass data as inversions or rotations of the PN sequence, since sequence timing is well-established.

### Power Requirements

The FM receiver will use less than 100 mW when in use, and preferably less than 50 mW. The standby average power of the receiver when monitoring for emergency alerts shall be less than 2.5 mW, and preferably less than 1.25 mW. Assuming a 2 watt hour battery, an FM receiver in constant use may drain the phone's battery in as little as 20 hours, but that the idle monitoring use of the receiver should not drain the phone's battery for 800 hours and preferably 1600 hours, thus having little effect on battery life while in the emergency monitoring mode.

### FM Receiver Specifications

1. Third Order Intercept: One of the most important performance specifications of a wireless receiver is its dynamic range. The upper limit of dynamic range is traditionally specified as the third order input intercept, an excellent measure of resistance to cross modulation or overload. We alter this specification slightly to phrase it in terms of field strength.

The receiver shall have a third order input intercept measured with interferers at +400 KHz and +800 KHz with respect to a desired signal of 2 volts per meter.

For FM broadcast reception, we expect a third order input intercept of 126 dbμV/meter, equal to a field of 2 volts/meter. We never expect to experience such an RF field in practice, but if a pair of interferers with a field strength of 100 dbμV/meter were present, then with a 126 dbμV/meter intercept, the spurious signal generated would be 78 db below +126 dbμV/meter, or about 48 dbμV/meter. This means that on rare occasions, cross modulation could be observed. A tuned antenna would significantly reduce the likelihood of this occurrence. Note that this intercept translates into varying circuit IP3's . With a ¼ wave whip, this would call for a circuit IP3 of +13 dbm, whereas with an antenna 30 db less sensitive, the required circuit IP3 will be −17 dbm. If the latter case involves a high input impedance circuit, then the input circuit third order intercept would be something like 300 mV. Note that in this case, we would expect a strongest signal of about 20 mV. CMOS LNAs and mixers can achieve this performance without difficulty.

2. Sensitivity: This becomes important with embedded antennas. In FM broadcast receivers used with large antennas, this specification is normally meaningless. The receiver shall have, with an applied field strength of 45 db μV/meter and 67 KHz deviation, a mono audio S/N of at least 40 db. Our receiver shall have, with an applied field strength of 64 db μV/meter, and 67 KHz deviation, a stereo audio S/N of at least 40 db.

3. Selectivity: This measures the ability of an FM receiver to receive a desired frequency while rejecting another at some specific frequency spacing. The receiver will operate in mono with a desired signal of 45 db μV/meter modulated at 400 Hz with 67 KHz deviation and a first alternate signal at a field strength of 75 db μV/meter modulated at 1 KHz with 67 KHz deviation, with less than a 1 db decrease in signal-to-noise ratio.

The receiver shall be tested in stereo with a desired signal of 64 db μV/meter modulated at 400 Hz and 600 Hz on the left and right channels at a deviation of 67 KHz, and a first alternate signal at a field strength of 94 db μV/meter modulated at 500 Hz and 700 Hz on the left and right channels at 67 KHz deviation. The stereo signal to noise ratio shall not be degraded by more than 1 db.

4. Signal-to-Noise ratio: The receiver shall have, with a strong RF signal, a stereo signal-to-noise ratio of 50 db or better, measured with equal amplitude 400 hz and 1 KHz modulating tones on the left and right channels at a stereo deviation of 67 KHz. The field strength used here will be 80 db μV/meter.

5. Audio frequency response: The receiver shall have an audio frequency response in mono or stereo which is constant within ±1 db over the span of 30 hz to 13 KHz, and shall be no more than 3 db down at 15 KHz. This measurement shall be made in an RF field of 70 db μV/meter. This measurement shall be made with normal 75 microsecond US standard pre-emphasis in the FM generator.

6. Stereo separation: The stereo separation of the receiver measured at 400 hz and 1000 hz shall be greater than 30 decibels. The separation shall be greater than 25 db at frequencies up to 10 KHz. This performance will be tested at a field strength of 70 db μV/meter, checking Left into Right and Right into Left signals.

7. Audio Distortion: The FM receiver shall have less than 0.5% Total Harmonic Distortion in stereo mode when operated at a field strength of 70 db μV/meter. This measurement shall be made at 400 hz and 1000 hz tones with 50 KHz deviation including the stereo pilot.

8. Frequency Range: The FM receiver must tune the US standard FM radio band with frequency accuracy of ±10 KHz from 88.1 to 107.9 MHz.

9. Tuning Speed: The FM receiver must tune to a specified frequency quickly enough to efficiently receive for short time periods. The receiver shall achieve performance within 1 decibel of the steady state performance 5 milliseconds after power on. The radios synthesizer needs to be settled to within 10 KHz of its final frequency within 5 milliseconds after power on.

10. RDS Performance: Receivers should have Radio Data System (RDS) capability. The receiver device will at least be able to synchronize to an RDS stream, and pass 26 or 16 bit packets to a coupled processor. More comprehensive on-chip RDS processing capability is nice, but must allow complete software programmed decoding functions.

This is very low complexity messaging, with data rates of a few hundred bits per second, and is primarily of interest when the FM receiver is continuously operating. In this situation, some of the control and processing resources of the handset will be available, which will allow even downloadable updates to the RDS function.

RDS groups shall be decoded without error for 5 minutes with RDS deviations of ±2 KHz and ±7.5 KHz at a field strength of 70 dbμV per meter.

The RDS sensitivity, measured at a 99 percent correct packet rate, shall be better than 45 db μV per meter at ±7.5 KHz RDS deviation and better than 57 dbμV per meter at ±2 KHz RDS deviation

### Alerting

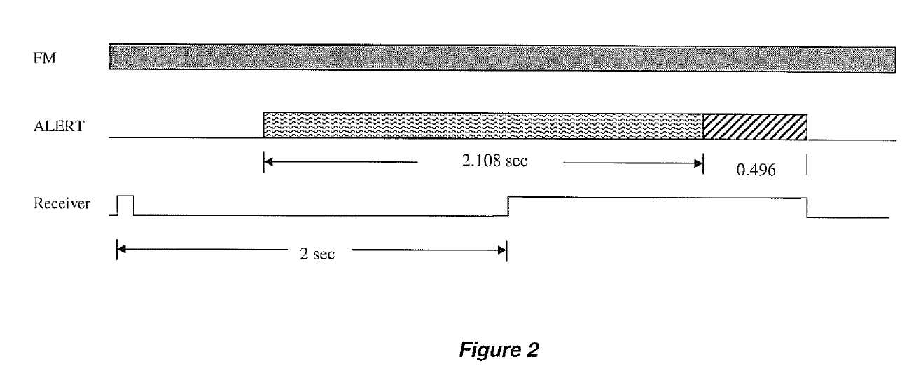

The preferred alerting system operates as follows: We use a normally inactive 14 KHz mono(L+R) in-band subcarrier, and modulate this with a chosen PN sequence of length 2̂5−1=31. This sequence would be sent at 1000 baud. With 100 percent root raised cosine filtering, the spectral zeros will occur ±1 KHz from the audio subcarrier, or at 13 KHz and 15 KHZ. This code will be sent for 2.108 seconds (see FIG. 2). At the end of the 2.108 second period, data identifying the emergency condition is sent for an additional 0.496 seconds, and conveys 64 data bits, which should be sufficient to convey any number of preset messages. No internal ECC is needed or desired. The entire sequence may then repeat.

Since this code has a length of 31, then the spreading gain is 15 decibels. This will allow reliable detection and message decoding when the S/N ratio of the audio subcarrier over a 1 KHz bandwidth is less than 0 db. An advantage of this over tone encoding is that it places a relatively broad high frequency modulated signal rather than distinct tones in the audio passband, and that it also allows instant synchronization. Enclosed with this specification is a file “nabalert.wav” which is ten seconds of the alerting signal as received in mono by a standard fm receiver with 75 microsecond de-emphasis combined with a reference level 440 Hz tone.

The receiving process for this is relatively straightforward. The intermittently (every 2 seconds) operated receiver will have a 10 KHz high pass filter, and a heterodyne process about the subcarrier frequency. Note that this is simplified if the receiver chip already presents a digitized audio output. The output(s) of the heterodyne process would be low-pass filtered. The resulting signals would be sampled at 2 KHz (complex) and, if necessary, coarsely (3 or 4 bits) quantized. The stored samples are then reordered, and processed with a fast 32 bit Walsh-Hadamard transform, which is equivalent to a circular correlator for the PN pattern. This gives the precise timing of the pattern in addition to its correlation value.

The fast Walsh-Hadamard transform consists, from a processing point of view, of 80 additions and 80 subtractions. Thus, the correlation processing for this, done very thoroughly, with fractional timing and arbitrary phase rotation, would be 320 adds and 320 subtracts. The memory required would be 62 locations for I samples and 62 locations for Q samples, plus a like amount for answers. Thus, the total RAM requirement would be less than 256 locations. The embedded program for this is very structured and therefore small, maybe a few hundred bytes. All of the data processing can be done with 8 bit words, so that the simplest processors can do this work.

In terms of processing time, a very simple single operand processor might need about 12 clocks per add or subtract including memory access. With a 50 MHz (very slow) processor, this would indicate a processing time of 150 microseconds. If a 50 MHz processor used 10 milliamps (again poor performance) at 1 volt, then the energy used would be 1.5 micro-joules per detection. This is much less than the energy cost of operating a receiver for 50 ms. We note that 15 micro-joules every 2 seconds consumes 8 microwatts, which is inconsequential.

To summarize the scheme, we would use a 2.108 second burst of a repeating PN pattern of length 31 as an alert. This pattern is BPSK (Binary Phase-Shift Key) modulated onto an audio subcarrier at the 14 KHz. After the 2.108 second interval, 16 cyclically rotated codes would be sent, conveying 64 bits total. This signal will be extremely robust, and resistant to false alarms and poor signal quality, since it will function reliably at a 0 db audio s/n ratio. While BPSK is preferred, those of skill in the art that other modulation schemes may be used, including frequency-shift keyed (FSK), minimum frequency-shift keying or minimum-shift keying (MSK), continuous phase modulation (CPM), etc.

We note that a reliable RDS emergency alert requires about a 40 db mono audio S/N. Thus, there is an enormous (about 40 decibels) performance difference between the proposed scheme and RBDS. The integration of the proposed schemes into FM receiver chips would cost at most pennies, since some of the FM capable devices have digital audio outputs already and processors capable of the necessary decoding arithmetic.

In conclusion, the RBDS emergency alerting function is inadequately reliable, and poorly suited to very low duty cycle intermittent receivers. Any practical implementation will have poor coverage with unacceptable power consumption. A heavily coded, in-band 14 KHz data subcarrier at high deviation is dramatically (40 db) more robust than RBDS signaling, and interferes less with program audio than the old EBS sequence. The added cost for implementing this in embedded receivers is very small, probably a few cents. The power consumption is modest and the coverage meets or exceeds the mono footprint, with minimal disturbance of program material.

I claim:

1. An FM alert system, comprising:
a transmitter that transmits a signal on a normally inactive mono(L+R) in-band FM subcarrier; and
a receiver that wakes up on a periodic basis to determine if the signal is present.

2. The system of claim 1, wherein the receiver wakes up at a rate of a few tenths of a hertz to a few hertz

3. The system of claim 1, wherein the transmitted signal is above 13 KHz.

4. The system of claim 1, wherein the transmitted signal is binary phase-shift key (BPSK) modulated.

5. The system of claim 1, wherein the transmitted signal is binary phase-shift key (BPSK) modulated at 1000 baud.

6. The system of claim 1, wherein the transmitted signal is binary phase-shift key (BPSK) modulated with a pseudo-noise (PN) sequence.

7. The system of claim 1, wherein the transmitted signal is binary phase-shift key (BPSK) modulated with a pseudo-noise (PN) sequence of length 2̂5−1=31.

8. The system of claim 1, wherein the transmitted signal is binary phase-shift key (BPSK) modulated with a pseudo-noise (PN) sequence of length 2̂5−1=31 for 2.108 seconds.

9. The system of claim 1, wherein after a sufficient amount of the signal is detected, an alarm or data is received.

10. The system of claim 1, wherein after a sufficient amount of the signal is detected, an alarm or data relating an emergency situation is received.

11. The system of claim 1, wherein the transmitted signal is followed by a data sequence comprising 16 rotated PN sequences (64 bits) for 0.496 seconds.

12. The system of claim 1, wherein the receiver forms part of a cellular telephone.

13. The system of claim 1, wherein a plurality of transmitters transmit the signal redundantly.

14. The system of claim 1, wherein the signal is transmitted above 1.3 KHz.

15. The system of claim 1, wherein the signal is transmitted at 14 KHz.

16. The system of claim 1, wherein the signal is transmitted at 14 KHz using two tones about half a semitone apart resulting in 14.5 KHz and 14.925 KHz.

17. The system of claim 1, wherein:
the signal is transmitted at 14 KHz using two tones about half a semitone apart resulting in 14.5 KHz and 14.925 KHz; and
the receiver heterodynes the signal with 15 KHz and low pass filters at 1 KHz, yielding 500 Hz and 75 Hz signals as outputs when the alert is present.

18. The system of claim 1, wherein the transmitted signal is frequency-shift key (FSK) modulated.

19. The system of claim 1, wherein the transmitted signal is minimum frequency-shift key or minimum-shift key (MSK) modulated.

20. The system of claim 1, wherein the transmitted signal is continuous-phase modulated (CPM).
